(19) United States
(12) Patent Application Publication
(10) Pub. No.: US 2018/0297454 A1
(43) Pub. Date: Oct. 18, 2018

(54) FUNCTIONAL KEY ASSEMBLY WITH SYMBOL SHOWING FUNCTIONS AND ITS MANUFACTURING METHOD

(71) Applicant: NIO CO., LTD., Shanghai (CN)

(72) Inventor: Fengzhan WU, Shanghai (CN)

(21) Appl. No.: 15/955,920

(22) Filed: Apr. 18, 2018

(30) Foreign Application Priority Data
Apr. 18, 2017 (CN) 201710254401.3

(51) Int. Cl. B60J 5/04; B60R 1/02; B60N 2/75; B29C 45/16

(52) U.S. Cl. CPC B60J 5/0416; B60R 1/025; B60N 2/797; B60R 2011/0021; B60J 5/0415; B60J 5/0469; B29C 45/1657; B29C 45/1676

(57) ABSTRACT

The present application provides a functional key assembly with symbol showing function and its manufacturing method. Specifically, in this application, the symbol of the functional key is provided on the inner surface of the function showing component or outer protective plate, to eliminate the provision of the parting line. Being manufactured by over-injection molding, the protective plate is provided with a carved structure at its inner portion and a back component at its lower portion such that the image of the symbol of the function key is cast onto the surface of the protective plate through the carved structure in backlit environment and is invisible without back lit, immerging effect is thus achieved, as a result of which, the armrest plate is therefore artistically decorated and less costly to manufacture at the same time.

### CROSS-REFERENCE TO RELATED APPLICATION

This application claims the benefit of China Patent Application No. 201710254401.3 filed Apr. 18, 2017, the entire disclosures of which are incorporated herein by reference in its entirety.

### TECHNICAL FIELD

The present application relates to the field of vehicle electronic system, particularly to a functional key assembly with symbol showing functions and its manufacturing method.

### BACKGROUND

The switch protective plate of a vehicle, as part of the armrest region of the door panel trim, is mainly used for fixing and assembling of the regulating switch. In the design of most of vehicle bodies, the regulating switch is directly installed onto the armrest and becomes part of the door panel trim. Being separated from each other, however, the panel of the regulating switch and that of the armrest is assembled together by means of installment. Accordingly, there is usually a parting line on them onto which an occupant is accustomed to put his/her arm. The arm feels less comfortable than expectancy owing to the existence of the parting line. Furthermore, whether the regulating switch is in use or not, most of the functional key symbols on the switch panel are turned on and the appearance of the armrest region is more or less affected.

In the prior art, the regulating switch is integrated into a module which is then assembled on the armrest, therefore it is necessary to define the functional key symbols, the illuminating effects and the material of the armrest so as to complete the overall design solution of the regulating switch on the armrest panel. Nowadays, the high light effect of the armrest region on the vehicle door handle is typically realized by means of high light paint or IMD(In-Mould Decoration)/IML(In-Mould Labelling). Most of the functional key symbols are directly formed on the armrest region or the surface of the regulating switch module by painting or Laser Etching, or a symbolic piece with symbols and the regulating switch module are both embedded into the armrest assembly, as a result of which, this design solution will not only result in a higher manufacturing cost but also be inconvenient for users to make out the adjusting functional key symbol immediately under a circumstance of dim light without an extra light source in the vehicle.

Accordingly, there is a need for a new functional key assembly to resolve the previously mentioned problems.

### SUMMARY

To resolve the above problems in the art, i.e., that the switch protective plate of vehicle is costly to manufacture and the comfort and appearance of the protective plate region needs to be improved, the present application provides a functional key assembly with symbol showing functions. The functional key assembly comprises a protective plate and a function showing component provided under the plate, the function showing component includes a symbol unit and an illumination module, wherein the symbol unit includes a symbol carrying part and at least one symbol carried on the symbol carrying part, and the illumination module includes a light source and a light guiding unit for fixing the light source and leading the light emitted by the light source to the symbol, furthermore, the protective plate is designed that the symbol is visible when it is illuminated by the light source and invisible when it is not.

In a preferred technical solution of the previously mentioned functional key assembly, the protective plate includes a lower layer and an upper protective layer with a certain light transmittance which is on the lower layer, wherein the lower layer is of a light transmission part corresponding to the symbol, and the remainder of the lower layer is a light-proof part.

In a preferred technical solution of the previously mentioned functional key assembly, the symbol carrying part is formed by applied a side of the upper protective layer facing the light transmission part with matte paint of predetermined color, and the symbol carrying part is carved into the symbol; the light-proof part of the lower part is of the predetermined color.

In a preferred technical solution of the previously mentioned functional key assembly, the symbol carrying part is formed between the light guiding unit and the light transmission part by applying a light transmission material including matte paint of predetermined color, and the applied part of the symbol carrying part applied with matte paint of predetermined color is carved into the symbol; the light-proof part of the lower part is of the predetermined color.

In a preferred technical solution of the previously mentioned functional key assembly, the predetermined color is black.

In a preferred technical solution of the previously mentioned functional key assembly, the light transmittance is 25%.

In a preferred technical solution of the previously mentioned functional key assembly, the upper protective layer is made from a PC (Polycarbonate) material.

In a preferred technical solution of the previously mentioned functional key assembly, the predetermined color is the same as that of the vehicle body where the functional key assembly is located.

In a preferred technical solution of the previously mentioned functional key assembly, the light transmission part is formed by carving or from a transparent material.

In a preferred technical solution of the previously mentioned functional key assembly, the functional key assembly is the rearview mirror functional key assembly for adjusting the vehicle rearview mirror, and the symbol indicates the adjusting function that the vehicle rearview mirror will carry out, wherein the rearview mirror performs the respective adjusting function when the symbol is chosen.

On the other hand, the present application provides a door handle assembly provided on the inside of the vehicle door. The door handle assembly comprises the functional key assembly with any one of above described symbol showing functions, wherein the protective plate of the functional key assembly is integral with the protective plate of other buttons on the door handle assembly.

In a preferred technical solution of the previously mentioned door handle assembly, the other buttons include any one or both of a window adjusting button and a vehicle door adjusting button of the vehicle.

In still another aspect, the application provides a vehicle door. It comprises any one of the previously mentioned functional key assemblies with symbol showing functions or any one of the door handle assemblies provided on the inside of the vehicle door.

In yet another aspect, the application provides a method for manufacturing functional key assembly with symbol showing functions. The method comprises the steps of: forming an upper protective layer with a certain light transmittance; forming a lower layer with a light transmission part and a light-proof part below the upper protective layer; and connecting a pre-fabricated function showing component to the lower layer. The function showing component includes a symbol unit and an illumination module, wherein the symbol unit includes a symbol carrying part and a symbol carried by the part, and the illumination module includes a light source and a light guiding unit which is used for fixing the light source and leading its light to the light guiding unit of the symbol, the symbol corresponds to the light transmission part when the pre-fabricated function showing component is connected to the lower layer such that the symbol is visible when it is illuminated by the light source and invisible when it is not.

In a preferred technical solution of the previously mentioned method, the method further includes: forming the symbol carrying part by applying a side of the upper protective layer facing the light transmission part with matte paint of predetermined color, and the symbol carrying part is carved into the symbol; the light-proof part of the lower part is of the predetermined color.

In a preferred technical solution of the previously mentioned method, the symbol carrying part is formed between the light guiding unit and the light transmission part by applying a light transmission material including matte paint of predetermined color. The method further comprises: the applied part of the symbol carrying part is carved into the symbol; and the light-proof part of the lower part is of the predetermined color.

In a preferred technical solution of the previously mentioned method, the predetermined color is black.

In a preferred technical solution of the previously mentioned method, the light transmittance is 25%.

In a preferred technical solution of the previously mentioned method, the upper protective layer is made from a smoky gray PC material with 25% light transmittance.

In a preferred technical solution of the previously mentioned method, the upper protective layer and/or the lower layer is manufactured by injection molding.

It should be understood by those skilled in the art that, in the technical solutions of the present application, it is improved that the previous design solution in the prior art provides the separately provided symbolic piece and embeds them into the armrest protective plate together with a regulating switch module. Specifically, the functional key symbol is directly provided on the function showing component or the inner surface of the outer protective layer, then the function showing component is assembled to the lower surface of the protective plate which thus has no parting line to be designed, and the back lit part of the function showing component can give off and guide light. Consequently, the image of the illuminated functional key symbol is cast onto the protective plate through the carved structure and the image disappears when the light source of the back lit part is turned off, thus achieving a beautiful and practical immerging effect of the symbol.

Additionally, the protective plate of the function key assembly with immerging symbol showing function is manufactured by over-injection molding, and only the symbol is processed by means of painting and Laser Etching in order that the protective plate in possession of the appearance of high light black color and a greatly reduced manufacturing cost.

### BRIEF DESCRIPTION OF DRAWINGS

FIG. 1 is a cross sectional schematic view of the structure of a functional key assembly with immerging symbol showing function according to the present application;

FIG. 2 is a schematic assembly view of a functional key assembly with immerging symbol showing function according to the present application;

FIG. 3 is a symbol showing effect view of the protective plate with immerging symbol showing function according to the present application;

FIG. 4 shows the symbol immerging effect of the protective plate with symbol showing function according to the present application;

FIG. 5 is a flow chart of the main steps of the manufacturing method of the functional key assembly with immerging symbol showing function according to the present application;

FIG. 6 is a flow chart of the specific steps of the embodiment 1 of the manufacturing method of the functional key assembly with immerging symbol showing function according to the present application; and

FIG. 7 is a flow chart of the specific steps of the embodiment 2 of the manufacturing method of the functional key assembly with immerging symbol showing function according to the present application.

### DETAILED DESCRIPTION

The preferred embodiments of the present application will be described below with reference to the accompanying figures and in conjunction with a rearview mirror adjusting device on the inner armrest of a vehicle door. As will be understood by those skilled in the art, these embodiments are merely used for interpreting the technical principle of the present application and are not intended to limit its protection scope in any way. Instead, it can be modified as desired to accommodate specific applications by those skilled in the art. For example, although in a preferred embodiments a rearview mirror adjusting function button on the inside of a vehicle door is described, the technical solutions of the present application are not limited to this but able to be applied to other vehicle keys or to keys on other equipments except for vehicles without departing from the principle of the present application.

It should be noted that, in the description of the present application, the usage of such directional and positional terms as upper and lower, is based on the directional and positional relations shown in the drawings, and used to facilitate the description itself and does not express or imply the necessary specific positions or specific operational and structural positions of the devices or elements of the disclosure. Therefore, the usage is not to be understood as limitation on the present application.

Moreover, it should also be noted that, in the description of the present application, unless otherwise specified and defined, the terms of install and connect, should be construed in their broad meaning, which can be understood as permanent or detachable or integrally connecting, mechanically or electrically connecting, direct connecting or indirect connecting via a third part, or even connecting between the inner parts of two elements. Those skilled in the art could interpret the specific meanings of the above-mentioned terms based on the context.

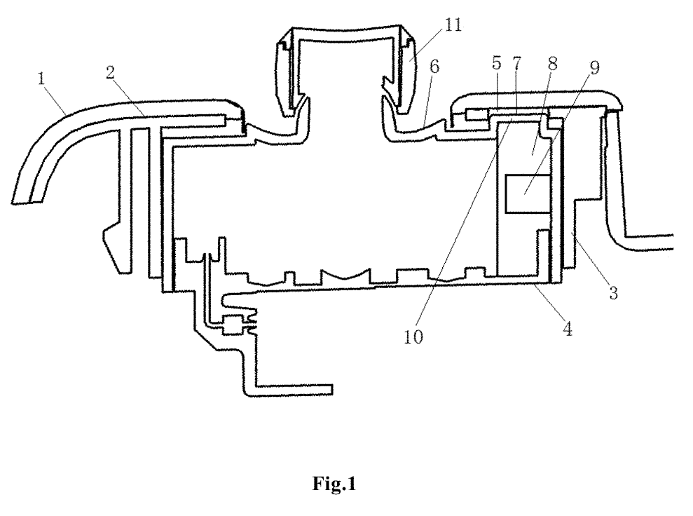

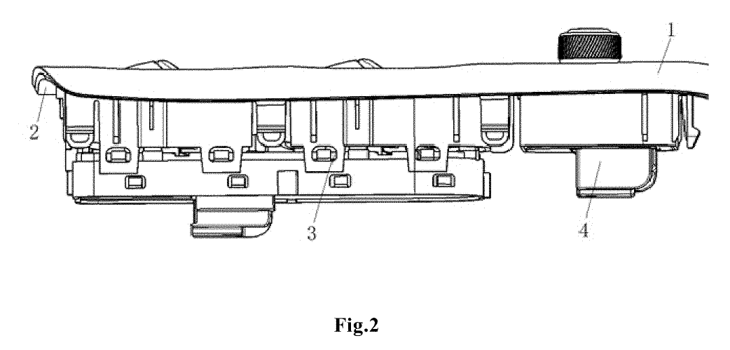

FIG. 1 is a cross sectional schematic view of the structure of a functional key assembly with symbol showing function according to an example of the present application. FIG. 2 is a schematic view of a functional key assembly with symbol showing function incorporated into the inner door handle of a vehicle door. It should be pointed out that, in the example in FIG. 2, the functional key assembly shown in FIG. 1 is provided on the right side of the door handle in FIG. 2, and the illustrative direction of the functional key assembly shown in FIG. 1 (vertically seeing into the principal plane of the FIG. 1) is reverse to that of the functional key assembly in FIG. 2 (vertically seeing into the principal plane of FIG. 2).

With reference to FIG. 1 and FIG. 2, the functional key assembly with symbol showing function in an example according to the present application comprises a protective plate and a function showing component provided under the protective plate. The function showing component includes a symbol unit and an illumination module. The symbol unit includes a symbol carrying part 10 and a symbol 7 carried by the symbol carrying part 10. The illumination module includes a light source 9 and a light guiding unit 8 which is used for fixing the light source and leading light from the light source 9. The protective plate is disposed that the symbol 7 is visible when it is illuminated by the light source and invisible when it is not.

According to an example according to the present application, the protective plate includes a lower layer 2 and an upper protective layer 1 with a certain light transmittance on the lower layer 2, wherein the light transmittance is for example 25% to 50%, preferably 25%. The lower layer 2 is of a light transmission part corresponding to the symbol 7, and the remainder of the lower layer 2 is a light-proof part. In the example of FIG. 1, the light transmission part is a carved part 5 or formed from transparent material or a material with higher light transmittance.

For example, the upper protective layer 1 and the lower layer 2 of the protective plate can be formed by two separate injection molding, by means of the first of which the upper protective layer 1 with a certain light transmittance is formed and by means of the second of which the light transmission part of the lower part 2 is formed under the protective layer 1 and the light-proof part for example the carved part 5 is formed corresponding to the symbol 7. According to the present application, an injection molding material of the upper protective layer 1 may be a material with 25% light transmission and a predetermined color. The selection of the predetermined color depends on user demands, for example the required color of the functional key assembly in its application circumstance. For instance, in an example described below, the functional key assembly is located onto the vehicle armrest plate, in which circumstance the protective plate of the functional key assembly needs to be of black substantially the same as that of the vehicle armrest plate without being illuminated by the light source, then the upper protective layer 1 can be made from a smoky gray PC material with 25% light transmittance and the lower layer 2 is made from black material with low light transmittance, for example the mixture of PC material and ABS, whose color is black during the manufacturing process.

With reference to FIG. 1, the body of the functional key assembly includes a knob 11 and a base 6. In the example shown in FIG. 1, the symbol carrying part 10 is part of the base 6, or the part of the base 6 corresponding to the symbol 7 is used as the symbol carrying part 10. The symbol carrying part 10 enables light to pass through, but other part of the base 6 is or is not a light transmission part. Instead, the part of the base 6 corresponding to the carved part 5 can be provided with a light transmission element used as the symbol carrying part 10. As such, the part of the base 6 corresponding to the symbol carrying part 10 should have a higher light transmittance. According to an example of the present application, the symbol 7 is fixed onto the symbol carrying part 10 in the following manner that the part of the symbol carrying part 10 facing the protective plate is applied with black matte paint, and the applied part of the symbol carrying part 10 is carved into the symbol 7 by Laser Etching.

The illumination module is located under the base 6, particularly at which the module is capable of at least covering most of the symbol 7, such that the light emitted by the light source 9 can illuminate the symbol 7 after leading by a light leading unit 8. The light leading unit 8 has for example a cylindrical cavity within which the light source 9 is fixed, and the cylindrical cavity serves as a light leading channel. The illuminating device can be used for fixing the base 6 as desired, or in some alternative embodiments, the illuminating device also can be used for fixing other components, such as the component 4 outlined in FIG. 1 and described below.

In the example of FIG. 1, the function indicated by the symbol 7 is carried out by means of turning the knob 11 to select the symbol 7. The meaning and function of the symbol depends on what the functional key assembly is used for controlling.

In the example shown in FIG. 1, the body of the functional key assembly includes the knob 11 and the base 6, but as should be understood by those skilled in the art, the body can be designed not to include the knob 11, and the base 6 can be modified somewhat, such that the symbol 7 is selected by way of touching or pressing other than turning the knob 11

Instead, with respect to the functional key assembly detailed in conjunction with FIG. 1, the location of the symbol 10 is variable. The part of the upper protective layer 1 facing the carved part 5 may be served as the symbol carrying part. Specifically, the inner surface of the upper protective layer 1 facing the carved part 5 is applied with black matte paint and then carved into the symbol 7 for example by Laser Etching. In this example, the symbol carrying part 10 is part of the upper protective layer 1, and particularly it is a region on the inner surface of the upper protective layer 1 facing the carved part 5. And in this example, the part of the base 6 facing the carved part 5 must be a light transmission part. As described above, the carved part 5 may not be carved into, instead it may be the light transmission part of the lower layer 2.

In all the examples of this disclosure, the light transmittance of the base 6, the light transmission part of the base 6 and the light transmission part of the lower layer 2 is preferably designed to allow the light emitted by the light source 9 to substantially pass through the mentioned components/parts.

In the examples of above described functional key assembly, there can also be provided under the protective plate with a fixing component 3 under the aid of which the functional key assembly is fixed to other components as desired. The fixing component 3 can be either directly located on a suitable area of the lower layer 2 or located to another layer formed on the lower layer 2. Furthermore, the specific structure of the fixing component 3 can be formed as desired.

The functional key assembly shown in FIG. 1 can be installed to a suitable location inside the vehicle, and the color of the upper protective layer and the lower layer is chosen according to that of the environment such that the symbol 7 will be visible by users when the light source 9 is turned on, and will be invisible when the light source 9 is turned off since its color is consistent with that of the lower layer 2. Still further, because the color of the upper protective layer 1 and the lower layer 2 of the protective plate of the functional key assembly is determined based on the color of the region of the vehicle in which the layers are situated, the symbol is invisible and of the same color as the whole protective plate of the functional key assembly when the light source 9 is turned off and the symbol 7 is visible when the light source is turned on.

In the examples described in this disclosure, the light source 9 is optionally a LED light. Although only one symbol is mentioned in the context, there can be more than one symbol 7 in this application.

The functional key assembly shown in FIG. 1 can be served as the functional key assembly used for adjusting the rearview mirror of the vehicle. The functional key assembly for adjusting the rearview mirror of the vehicle includes different symbols indicating different functions, such as adjusting upward or downward the rearview mirror and heating the rearview mirror, etc. Here, taking the symbol indicating heating as an example, the symbol 7 indicating heating is positioned onto the symbol carrying part 10, and when the light source 9 is turned on, the light emitted by it is directed to the symbol 7 through the light guiding unit 8. The functional key assembly is connected to the mirror body 4, it should be noted that, the rearview mirror body 4 given here is merely illustrative. As should be understood by those skilled in the art, the rearview mirror body can include more components and will not be described further so as to emphasize the key points of the present application. When the rearview mirror needs to be heated, the knob 11 points at the heating symbol 7 by its indicator and the rearview is heated.

As previously mentioned, FIG. 2 is an illustration of a functional key assembly with symbol showing function incorporated into the inner door handle of a vehicle door shown in FIG. 1. In other words, FIG. 2 is the door handle protective plate assembly including the functional key assembly with the symbol showing function according to the example of the present application. More specifically, in this figure, the functional key assembly shown in FIG. 1 is used for adjusting the rearview mirror of the vehicle, and in this example, the door handle assembly also includes a vehicle window adjusting button(s) and/or a vehicle door controlling button(s). In the example shown in FIG. 2, the upper protective layer 1 and the lower layer 2 are part of the door handle protective plate, i.e. the protective plate of the door handle assembly, and a part of them is served as part of the rearview mirror functional key assembly for adjusting the vehicle rearview mirror. Compared with the example of integrating the rearview mirror functional key assembly for adjusting the vehicle rearview mirror into the door handle assembly including the vehicle window adjusting button(s) and/or vehicle door controlling button(s), the door handle assembly shown in FIG. 2 is integral with the whole protective plate, and no parting line mentioned in the above background exists. Furthermore, as mentioned above, on account of employing the structure of the functional key assembly as depicted in FIG. 1, the symbol related to the rearview mirror functional key assembly for adjusting the vehicle rearview mirror is invisible to on-board users when the light source 9 is turned off, and the whole symbol has an immerging effect when the light source 9 is turned on.

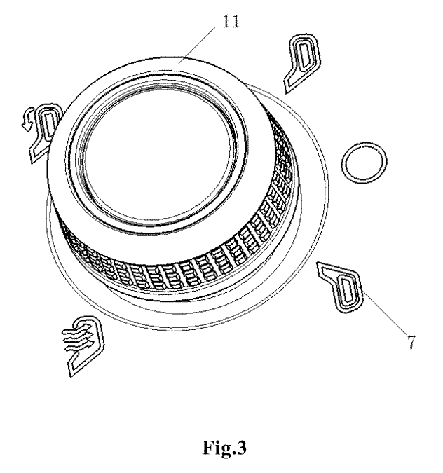

FIG. 3 is a symbol showing effect view of the button assembly with symbol showing function according to the present application, i.e. a symbol visible effect when the light source 9 is turned on. As shown in FIG. 3, the light emitted by the light source 9 is leaded along the light guiding channel 8 to the symbol 7, which is visible to on-board users though they are separated by the protective layer 1 (given that the button with symbol showing function is part of the door handle assembly shown in FIG. 2). It should be understood by those skilled in the art that, in addition to the symbol 7 shown in FIG. 3, other four symbols shown in FIG. 3 are similar to the symbol 7, and such number as one or four is also merely exemplary.

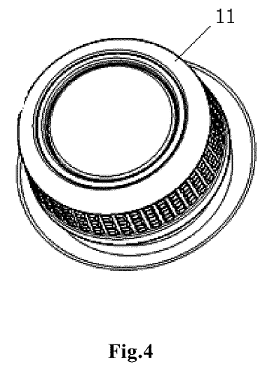

Referring next to FIG. 4, which shows the symbol immerging effect of the protective plate with symbol showing function according to the present application. That is to say, as shown in FIG. 4, when the light source 9 does not work, the symbol 7 is invisible to users on-board.

With regard to the light source, it should be noted that, the turning on and turning off of the light source can be realized as desired with a variety of ways, for example being provided with a separate switch or being incorporated into the whole electrical control system of the vehicle. Such variations do not depart from the principle and scope of the present application.

In the examples of the application, the symbol can be such schematic indicia as a character or an arrow, etc. Additionally, as a preferred example, the functional key assembly of the present application may be a vehicle functional key assembly, preferably a functional key assembly provided on the inside of the vehicle door and used for adjusting the vehicle window and/or the rearview mirror.

According to an example of the present application, the present application also provides a vehicle door on the inside of which a functional key assembly with symbol showing function as above described. The functional key assembly may be a functional key assembly for adjusting the rearview mirror or a functional key assembly for adjusting other objects. Or, the vehicle door includes a door handle assembly as previously mentioned.

A manufacturing method of the functional key assembly of the present application will be detailed below in conjunction with the above functional key assembly with immerging symbol function.

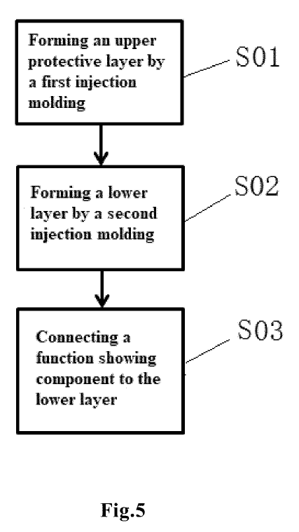

Referring next to FIG. 5, which is a flow chart of the main steps of the manufacturing method of the functional key assembly with symbol showing function according to the present application. As shown in FIG. 5, the manufacturing method of the functional key assembly with symbol showing function of the present application mainly comprises: step S01, forming an upper protective layer with a certain light transmittance. For example, the upper protective layer is manufactured by a material with 25% light transmission and a predetermined color, which has been explained above in conjunction with FIG. 1 and needs no repeat. According to a specific example of the present application, the upper protective layer is made from a gray PC material with 25% light transmission by injection molding. At step S02, forming a lower layer with a light transmission part and a light-proof part under the upper protective layer. According to some examples, the light transmission part can be of carved structure (i.e., through holes) or made from a transparent material (for example, a transparent PC material) and the light-proof part can be made from a light-proof material, which has been described above and needs no repeat. At step S03, connecting a pre-fabricated function showing component to the lower layer. The function showing component includes a symbol unit and an illumination module. The symbol unit includes a symbol carrying part and a symbol carried by the symbol carrying part. The illumination module includes a light source and a light guiding unit which is used for fixing the light source and leading the light emitted by the source to the symbol. When the pre-fabricated function showing component is connected to the lower layer, the symbol and the light transmission part are aligned with one another, such that the symbol is visible when it is illuminated by the light source and invisible when it is not. The function showing component may be for example one of those functional key assemblies described in the above examples and needs no repeat.

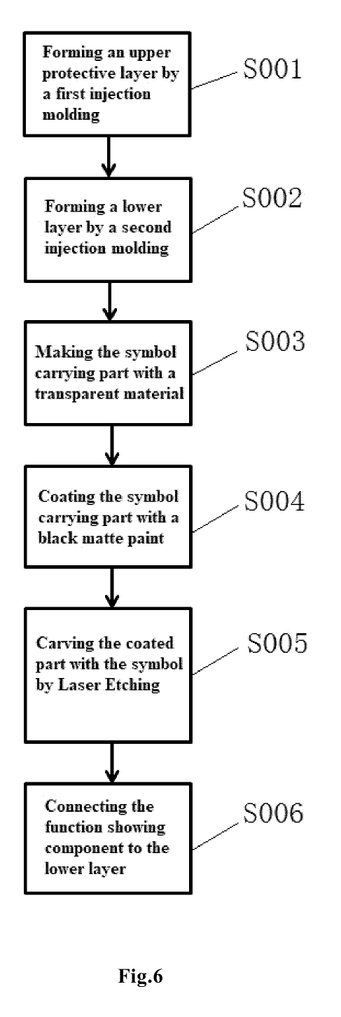

With reference next to FIG. 6, FIG. 6 is a flow chart of the specific steps of the embodiment 1 of the manufacturing method of the functional key assembly with showing function according to the present application. In this non-limiting example, the color shown after the upper protective layer is joined to the lower layer 2 is black. As shown in FIG. 6, at the step of S001, a smoky gray PC with 25% light transmittance is used as the injection molding material, enabling a first injection molding to form the upper protective layer. Next, at the step of S002, the mixture of a black PC material and ABS is used as the injection molding material, enabling a second injection molding under the molded upper protective layer to form the lower layer. Preferably, as the lower layer is molded, there is a carved structure or transparent part formed on the lower layer, in order that the light emitted by the light source is leaded to the symbol by the light guiding unit. Then, at the step of S003, a part of the function showing component, i.e. the symbol carrying part is made from a transparent PC material. Then, at the step of S004, the symbol carrying part is applied with a black matte paint. After the painting is finished, then at the step of S005, the applied part is carved into the symbol by Laser Etching. Finally, at the step of S006, the function showing component including the symbol unit and the illumination module is connected to the bottom of the lower layer.

It should be noted that, although the method of the present application is described hereinbefore in conjunction with a specific order, it is not limited to above mentioned and other specific orders. Without altering the basic principle of the present application, the method of the application can be carried out in any order. For example, the lower layer can be formed before the upper protective layer, and the main body structure of the function showing component, the symbol carrying part and the illumination element, etc. can be made prior to the molding of the protective plate, further, the manufacturing order of the components or elements of the function showing component can also be adjusted arbitrarily. Furthermore, the operations of the steps of the above mentioned method can be divided or combined, for example the step of S002 can be divided into injection molding and carving and the steps S003, S004 and S005 can be combined into a symbol manufacturing step, and so on. The divided or combined technical solutions do not depart from the principle of the present application and thus will fall in its protect scope.

When the functional key needs to be adjusted, the light emitted by a light source, such as a ELD light, passes through the light guiding channel to the symbol, the image of which is cast onto the surface of the protective plate through the carved structure and visible to users. When the functional key does not need to be adjusted, the light source, such as a LED light, will not emit light, so that the image disappears and the symbol is immersed into the protective plate and invisible to users.

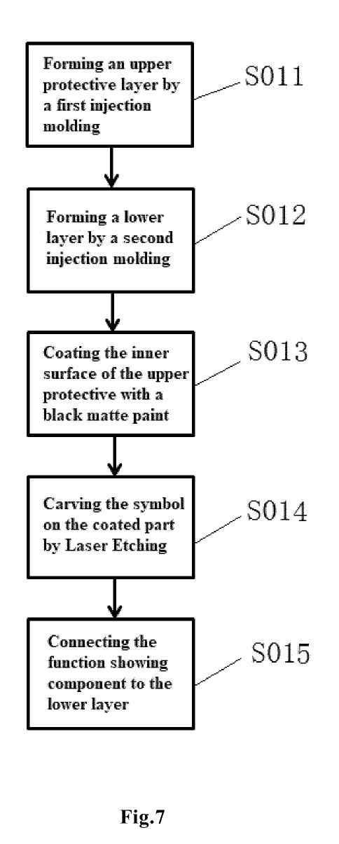

Finally, with reference to FIG. 7, FIG. 7 is a flow chart of the specific steps of the embodiment 2 of the manufacturing method of the functional key assembly with immerging symbol showing function according to the present application. As shown in FIG. 7, at the step of S011, preferably, a smoky gray PC material with 25% light transmittance is used as the injection molding material, enabling a first injection molding to form the upper protective layer. Next, at the step of S012, preferably, the mixture of black PC and ABS is used as the injection molding material, enabling a second injection molding under the molded upper protective layer to form the lower layer. Preferably, as the lower layer is molded, there is a carved structure or transparent part formed on the lower layer, in order that the light emitted by the illumination element is able to pass through the carved part or transparent part, such that the image of the symbol is cast onto the protective plate. Then, at the step of S013, the inner surface of the upper protective layer is applied with a black matte paint. After the painting is finished, then at the step of S014, the painted part is carved into the symbol by Laser Etching. Finally, at the step of S015, the function showing component including the symbol unit and the illumination module is connected to the bottom of the lower layer of fixing structure.

Similar to the method shown in FIG. 6, the method shown in FIG. 7 is not limited to the above mentioned and other specific orders, therefore the method shown in FIG. 7 can be carried out in any order. For example, the lower layer can be formed before the upper protective layer, or the symbol on the upper protective layer can be made prior to the molding of lower plate, and so on. Furthermore, the operations included in the steps of the above mentioned method can also be divided or combined, for example the step of S012 can be divided into injection molding and carving, and the steps S013 and S014 can be combined into a symbol manufacturing step, and so forth. The divided or combined technical solutions do not depart from the principle of the present application and thus will fall in its protect scope.

So far, the technical solutions of the present application have been described with reference to the preferred embodiments shown in the accompanying figures. As will be appreciated by those skilled in the art, however, these specific embodiments are not intended to limit protection scope of the application. It will be understood by those skilled in the art that, without departing from the principle of the application, various changes may be made and equivalents may be substituted for related technical features, the varied or substituted technical solutions will fall within protection scope of the application.

What is claimed is:

1. A functional key assembly with symbol showing function, wherein the functional key assembly comprises
a protective plate, and
a function showing component provided under the protective plate, wherein the function showing component includes
a symbol unit, and
an illumination module,
wherein the symbol unit includes a symbol carrying part and at least one symbol carried on the symbol carrying part, and the illumination module includes a light source and a light guiding unit for fixing the light source and leading the light emitted by the light source to the symbol, and the protective plate is designed that the symbol is visible when it is illuminated by the light source and invisible when it is not.

2. The functional key assembly with symbol showing function as set forth in claim 1, wherein the protective plate includes a lower layer and an upper protective layer with a certain light transmittance on the lower layer, wherein the lower layer is of a light transmission part corresponding to the symbol, and the remainder of the lower layer is a light-proof part.

3. The functional key assembly with symbol showing function as set forth in claim 2, wherein the symbol carrying part is formed by applying a side of the upper protective layer facing the light transmission part with matte paint of predetermined color, and the symbol carrying part is carved into the symbol; the light-proof part of the lower layer is of the predetermined color.

4. The functional key assembly with symbol showing function as set forth in claim 2, wherein the symbol carrying part is formed between the light guiding unit and the light transmission part by coating a light transmission material including matte paint of predetermined color, and the applied part of the symbol carrying part is carved into the symbol; the light-proof part of the lower part is of the predetermined color.

5. The functional key assembly with symbol showing function as set forth in claim 3, wherein the predetermined color is black.

6. The functional key assembly with symbol showing function as set forth in claim 2, wherein the light transmittance is 25%.

7. The functional key assembly with symbol showing function as set forth in claim 1, wherein the upper protective layer is made from a PC material.

8. The functional key assembly with symbol showing function as set forth in claim 3, wherein the predetermined color is the same as that of the vehicle body where the functional key assembly is located.

9. The functional key assembly with symbol showing function as set forth in claim 2, wherein the light transmission part is formed by carving or from a transparent material.

10. The functional key assembly with symbol showing function as set forth in claim 1, wherein the functional key assembly is a rearview mirror functional key assembly for adjusting the vehicle rearview mirror, and the symbol indicates the adjusting function that the vehicle rearview mirror will carry out, wherein the rearview mirror performs the respective adjusting function when the symbol is chosen.

11. A door handle assembly provided on the inside of the vehicle door, wherein the door handle assembly comprises the function key assembly with symbol showing function as set forth in claim 1, wherein the protective plate of the functional key assembly is integral with the protective plate of other buttons on the door handle assembly.

12. The door handle assembly provided on the inside of the vehicle door as set forth in claim 11, wherein the other buttons include any one or both of a window adjusting button and a vehicle door adjusting button of the vehicle.

13. A vehicle door, comprising (a) the functional key assembly with symbol showing function as set forth in claim 1 or (b) the door handle assembly provided on the inside of the vehicle door as set forth in claim 11.

14. A method for manufacturing a functional key assembly with symbol showing function, wherein the method comprises the steps of:
forming an upper protective layer with a certain light transmittance;
forming a lower layer with a light transmission part and a light-proof part under the upper protective layer;
connecting a pre-fabricated function showing component to the lower layer, wherein the function showing component includes
a symbol unit, and
an illumination module,
wherein the symbol unit includes a symbol carrying part and a symbol carried by the part, and the illumination module includes a light source and a light guiding unit which is used for fixing the light source and leading its light, the symbol corresponds to the light transmission part when the pre-fabricated function showing component is connected to the lower layer such that the symbol is visible when it is illuminated by the light source and invisible when it is not.

15. The method as set forth in claim 14, wherein the method further includes: forming the symbol carrying part by applying a side of the upper protective layer facing the light transmission part with matte paint of predetermined color, and the symbol carrying part is carved into the symbol; the light-proof part of the lower part is of the predetermined color.

16. The method as set forth in claim 14, wherein the symbol carrying part is formed between the light guiding unit and the light transmission part by applying a light transmission material including matte paint of predetermined color; and the method further includes: the painted part of the symbol carrying part is carved into the symbol; and the light-proof part of the lower part is of the predetermined color.

17. The method as set forth in claim 15, wherein the predetermined color is black.

18. The method as set forth in claim 14, wherein the light transmittance is 25%.

19. The method as set forth in claim 14, wherein the upper protective layer is made from a smoky gray PC material with 25% light transmittance.

20. The method as set forth in claim 14, wherein the upper protective layer and/or the lower layer is manufactured by injection molding.
